(19) United States
(12) Patent Application Publication
(10) Pub. No.: US 2024/0399973 A1
(43) Pub. Date: Dec. 5, 2024

(54) ROTATABLE HITCH-MOUNTED PAYLOAD ADAPTOR

(71) Applicants: CHARLES BLAKE OWEN, ALPINE, UT (US); BRYCE ALLEN OWEN, HIGHLAND, UT (US)

(72) Inventors: CHARLES BLAKE OWEN, ALPINE, UT (US); BRYCE ALLEN OWEN, HIGHLAND, UT (US)

(73) Assignee: EAST MOUNTAIN OUTFITTERS LLC, Lehi, UT (US)

(21) Appl. No.: 18/737,079

(22) Filed: Jun. 7, 2024

Related U.S. Application Data
(63) Continuation-in-part of application No. 18/155,696, filed on Jan. 17, 2023, now Pat. No. 12,005,866.
Application No. 18/155,696 is a continuation-in-part of application No. 17/339,562, filed on Jun. 4, 2021, now Pat. No. 11,554,724.
Application No. 17/339,562 is a continuation of application No. 17/003,094, filed on Aug. 26, 2020, now Pat. No. 11,572,022.
Application No. 17/003,094 is a continuation-in-part of application No. PCT/US2019/044865, filed on Aug. 2, 2019.
(60) Provisional application No. 63/626,355, filed on Jan. 29, 2024.
(60) Provisional application No. 62/715,203, filed on Aug. 6, 2018.
(60) Provisional application No. 62/841,933, filed on May 2, 2019.

(51) Int. Cl. B60R 9/10; B60R 9/06; B62H 3/12

(52) U.S. Cl. CPC B60R 9/10; B60R 9/06; B62H 3/12

(57) ABSTRACT

A coupling apparatus for rotating a hitch bar load relative to a major axis of a vehicle includes a hitch bar configured to couple to a vehicle hitch bar receiver, a rotation apparatus operatively coupled to the hitch bar and configured to rotate a rotatable hitch bar receiver relative to a major axis of the hitch bar and the vehicle. According to an embodiment, the load may be directly coupled to the rotation apparatus.

### CROSS REFERENCE TO RELATED APPLICATIONS

The present application claims priority benefit from U.S. Provisional Patent Application Ser. No. 63/626,355 (docket number 3065-004-02), entitled “ROTATABLE HITCH-MOUNTED PAYLOAD ADAPTOR,” filed Jan. 29, 2024 and is a Continuation-in-Part of U.S. patent application Ser. No. 18/155,696 (docket number 3065-001-08), entitled “ANTI-RATTLE HITCH MOUNTED RACK,” filed Jan. 17, 2023. U.S. patent application Ser. No. 18/155,696 is a Continuation-in-Part which claims priority benefit of U.S. patent application Ser. No. 17/339,562, entitled “BICYCLE RACK WITH C-HOOPS,” filed Jun. 4, 2021 (docket number 3065-001-07) which issued on Jan. 17, 2023 as U.S. Pat. No. 11,554,724. U.S. patent application Ser. No. 17/339,562 claims priority benefit of U.S. patent application Ser. No. 17/003,094, entitled “BICYCLE CARRIER AND BICYCLE STORAGE RACK,” filed Aug. 26, 2020 (docket number 3065-001-03) which issued Feb. 7, 2023 as U.S. Pat. No. 11,572,022. U.S. patent application Ser. No. 17/003,094 claims priority benefit of International Patent Application No. PCT/US2019/044865, entitled “BICYCLE CARRIER AND BICYCLE STORAGE RACK,” filed Aug. 2, 2019 (docket number 3065-001-04). International Patent Application No. PCT/US2019/044865 claims priority benefit from U.S. Provisional Patent Application No. 62/715,203, entitled “BICYCLE CARRIER AND BICYCLE STORAGE RACK,” filed Aug. 6, 2018, now expired. International Patent Application No. PCT/US2019/044865 also claims priority benefit from U.S. Provisional Patent Application No. 62/841,933, entitled “BICYCLE CARRIER AND BICYCLE STORAGE RACK,” filed May 2, 2019, now expired.

Each of the foregoing applications, to the extent not inconsistent with the disclosure herein, is incorporated herein by reference.

### SUMMARY

According to an embodiment, a coupling apparatus for rotating a hitch bar load relative to a major axis of a vehicle includes a hitch bar configured to couple to a vehicle hitch bar receiver, a rotatable hitch bar receiver, and a rotation apparatus operatively coupled between the hitch bar and the rotatable hitch bar receiver, configured to rotate the rotatable hitch bar receiver about a vertical axis relative to the hitch bar while preventing rotation of the rotatable hitch bar receiver about a horizontal axis and preventing translation of the rotatable hitch bar receiver.

According to an embodiment, a horizontally rotating vehicle hitch coupler includes a hitch bar configured to couple to a vehicle hitch bar receiver, a vertical axle housing operatively coupled to the hitch bar, a vertical axle rotatably supported by the vertical axle housing, and a rotatable hitch bar receiver operatively coupled to and configured to rotate with the vertical axle. An object coupled to the rotatable hitch bar receiver is rotatable around a vertical axis defined by the vertical axle housing and the vertical axle.

According to an embodiment, a vehicle trailer hitch payload includes a hitch bar configured to couple to a vehicle hitch bar receiver, a rotatable payload operatively coupled to and completely supported by the hitch bar for transport by the vehicle, and a rotation apparatus operatively coupled to the hitch bar and to the rotatable payload. The rotation apparatus is configured to rotate the rotatable payload about a vertical axis of rotation.

### BRIEF DESCRIPTION OF THE DRAWINGS

FIG. 1 is a view of a rotating vehicle hitch coupler, according to an embodiment.

FIG. 2 is an end view of the rotating vehicle hitch coupler of FIG. 1, according to an embodiment.

FIG. 3 is a right side view of the rotating vehicle hitch coupler of FIGS. 1 and 2, according to an embodiment.

FIG. 4 is a left side view of the rotating vehicle hitch coupler of FIGS. 1-3, according to an embodiment.

FIG. 5 is a sectional end view of the rotating vehicle hitch coupler of FIGS. 1-4, according to an embodiment.

FIG. 6 is a sectional side view of the rotating vehicle hitch coupler of FIGS. 1-5, according to an embodiment.

FIG. 7 is a top view of the rotating vehicle hitch coupler of FIGS. 1-6, according to an embodiment.

FIG. 8 is a bottom view of the rotating vehicle hitch coupler of FIGS. 1-7 with the rotatable hitch bar receiver in a position suitable for travel.

FIGS. 9A and 9B are bottom views of the rotating vehicle hitch coupler of FIGS. 1-8, showing respective selected rotated positions of the rotatable hitch bar receiver relative to the hitch bar, of according to an embodiment.

FIG. 10 is a diagram of a vehicle trailer hitch-mountable cargo carrier, according to an embodiment.

### DETAILED DESCRIPTION

In the following detailed description, reference is made to the accompanying drawings, which form a part hereof. In the drawings, similar symbols typically identify similar components, unless context dictates otherwise. Other embodiments may be used and/or other changes may be made without departing from the spirit or scope of the disclosure.

As used herein, the term axle housing refers to a body that supports one or more bearings, bushings, or the like for supporting an axle, the axle being configured to rotate relative to the axle housing. According to embodiments, an axle housing may be formed affixed to or integral with a hitch bar, such that a hitch bar receiver or load affixed to or integral with the axle can rotate relative to the hitch bar. According to other embodiments, the axle housing may be formed affixed to or integral with a hitch bar receiver or load, such that the hitch bar receiver or load can rotate relative to an axle affixed to or integral with the hitch bar. According to embodiments, the axle housing includes bearings, bushings, or the like configured to substantially prevent axial movement of the axle, so that a rotatable hitch bar receiver or load is supported vertically.

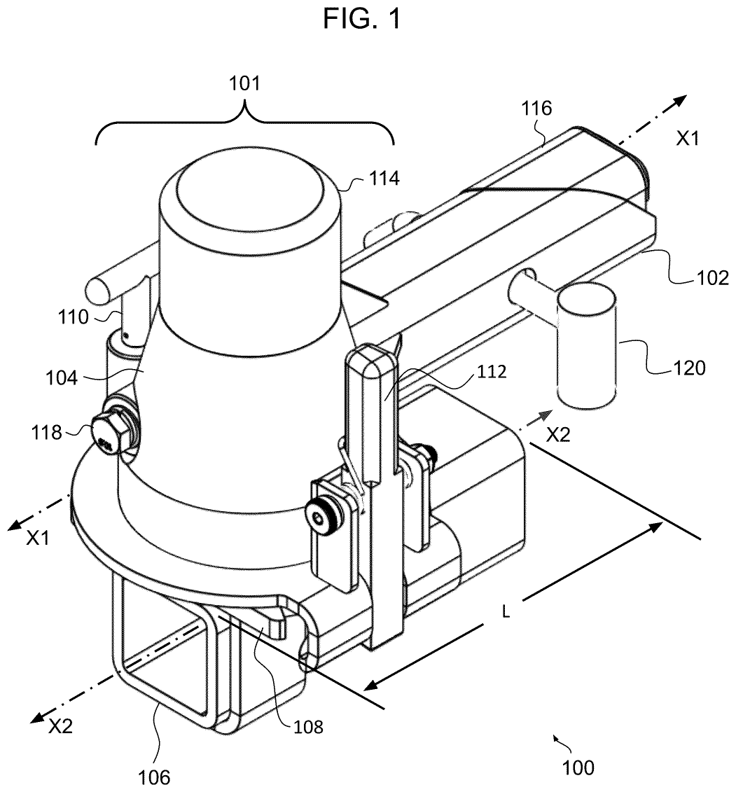

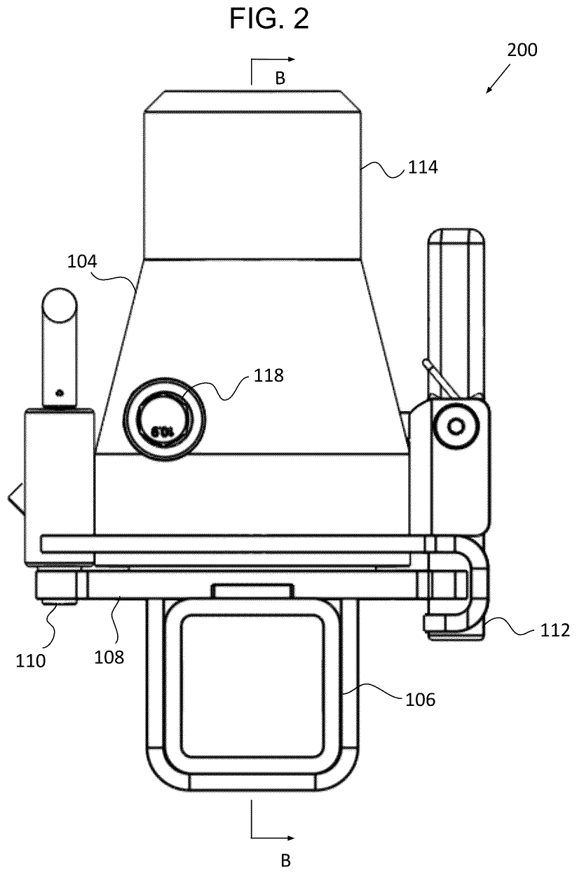

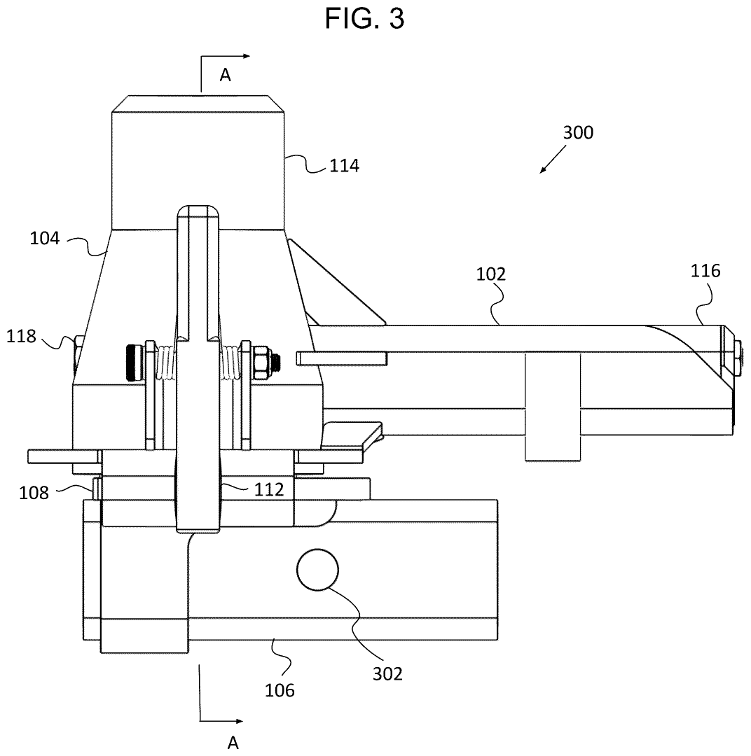

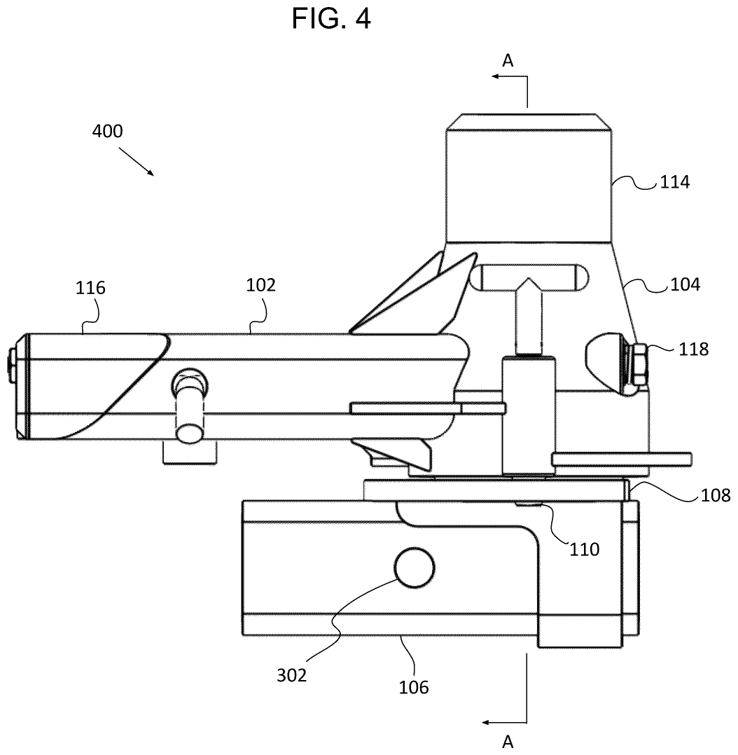

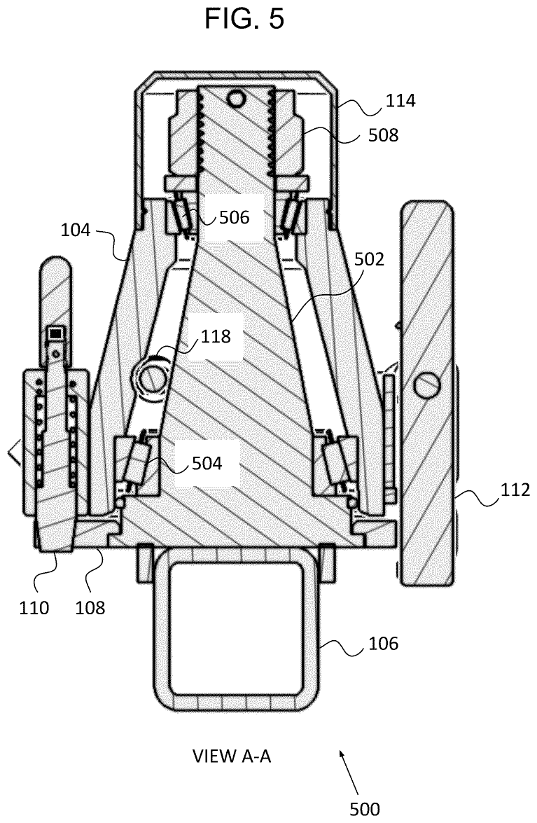

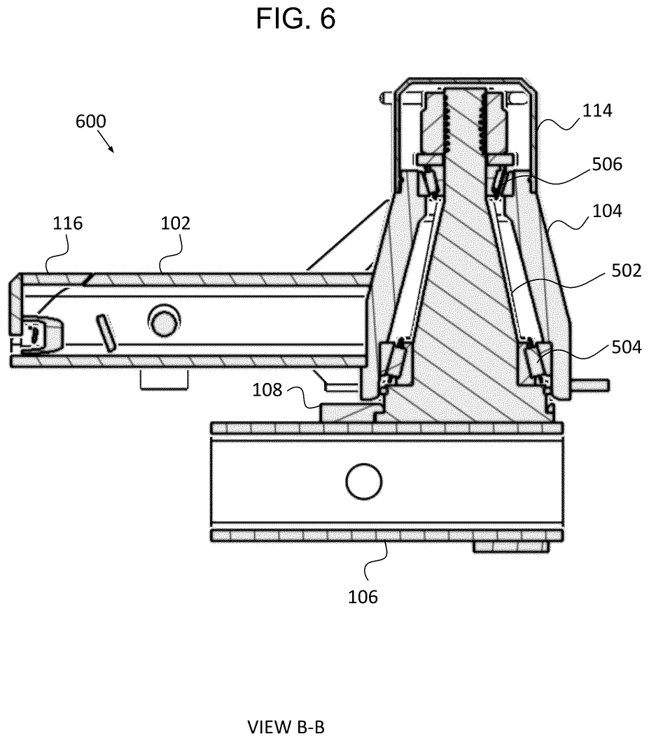

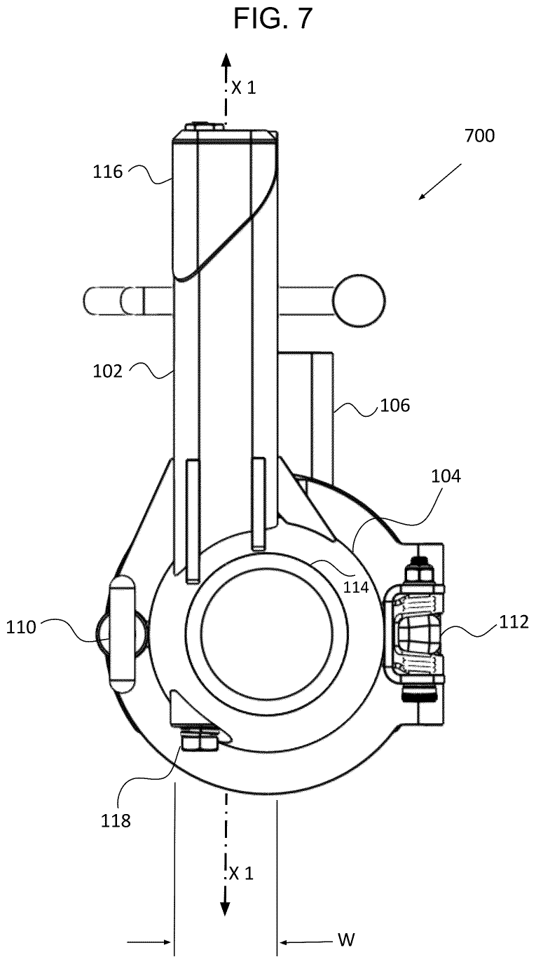

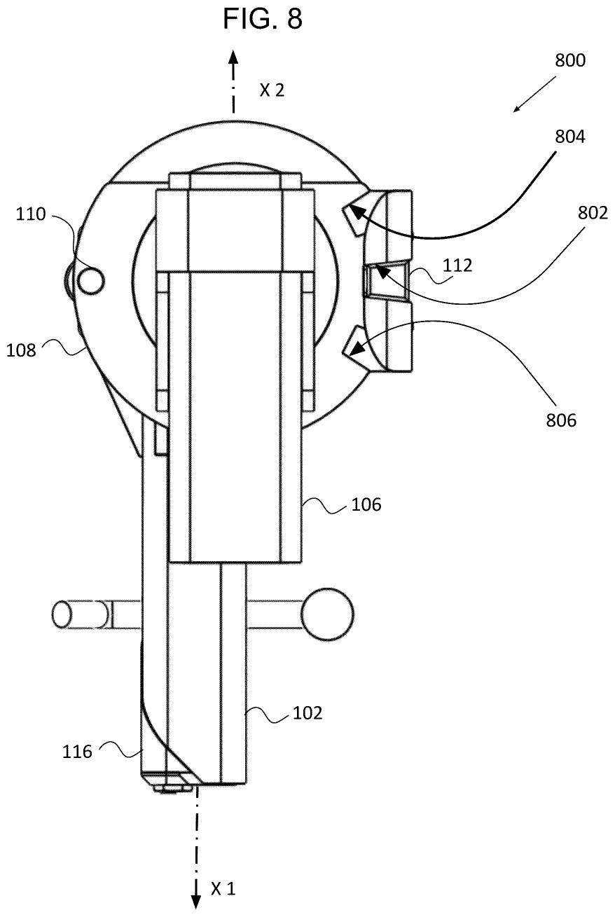

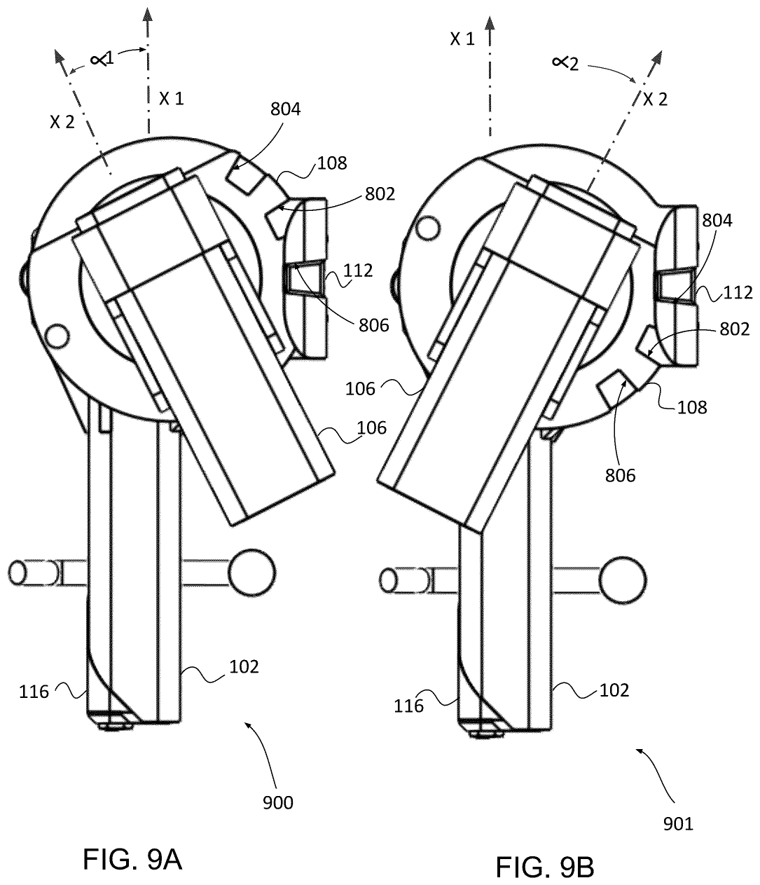

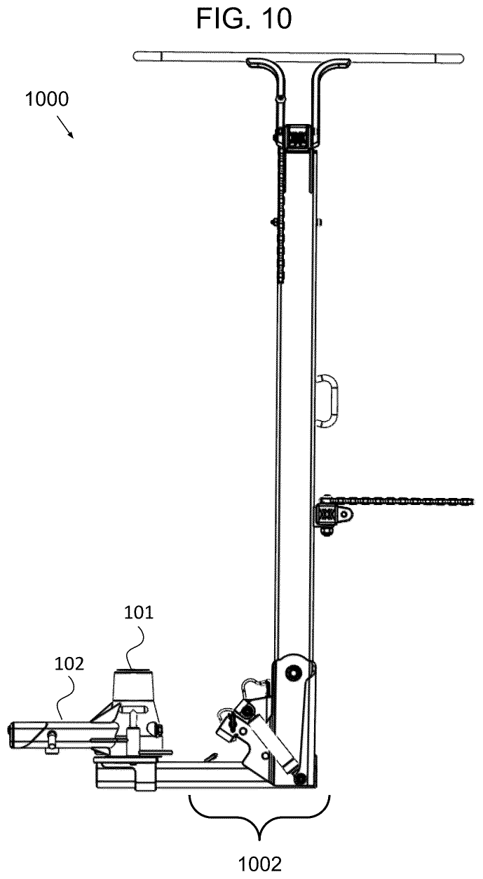

FIG. 1 is a view of a rotating vehicle hitch coupler 100, according to an embodiment. FIG. 2 is an end view 200 of the rotating vehicle hitch coupler 100 of FIG. 1, according to an embodiment. FIG. 2 defines a plane B-B. FIG. 3 is a right side view 300 of the rotating vehicle hitch coupler 100 of FIGS. 1 and 2, according to an embodiment. FIG. 3 defines a plane A-A. FIG. 4 is a left side view 400 of the rotating vehicle hitch coupler 100 of FIGS. 1-3, according to an embodiment. FIG. 5 is a sectional end view 500 of the rotating vehicle hitch coupler 100 of FIGS. 1-4 at the plane A-A, according to an embodiment. FIG. 6 is a sectional side view 600 of the rotating vehicle hitch coupler 100 of FIGS. 1-5 at the plane B-B, according to an embodiment. FIG. 7 is a top view 700 of the rotating vehicle hitch coupler 100 of FIGS. 1-6, according to an embodiment. FIG. 8 is a bottom view 800 of the rotating vehicle hitch coupler 100 of FIGS. 1-7 with the rotatable hitch bar receiver 106 in a position where a major axis X₂ of the rotatable hitch bar receiver 106 is parallel to a major axis X₁ of the hitch bar 102, according to an embodiment. FIGS. 9A and 9B are bottom views 900, 901 of the rotating vehicle hitch coupler 100 of FIGS. 1-8 showing respective selected rotated positions, shown as angles alpha 1 (α₁) and alpha 2 (α₂), of a major axis X₂ of a rotated hitch bar receiver 106 relative to a major axis X₁ of the hitch bar 102, according to an embodiment. FIG. 10 shows an embodiment where a load is directly coupled to the rotation apparatus 101 in place of the rotatable hitch bar receiver 106, according to an embodiment.

Description herein variously references FIGS. 1-8, 9A, 9B, and 10. The first digit of a reference number indicates the first figure where the referenced object is labeled.

According to an embodiment, a coupling apparatus 100 for rotating a hitch bar load relative to a major axis of a vehicle includes a hitch bar 102, a rotatable hitch bar receiver 106, and a rotation apparatus 101 coupling the hitch bar 102 to the rotatable hitch bar receiver 106. The hitch bar 102 has a major axis X₁ and a width W, and is configured to couple to a vehicle hitch bar receiver (not shown). The rotatable hitch bar receiver 106 has a major axis X₂. The rotation apparatus 101 is operatively coupled to the hitch bar 102 and the rotatable hitch bar receiver 106, and is configured to rotate the rotatable hitch bar receiver 106 about a vertical axis relative to the hitch bar 102 while preventing rotation of the rotatable hitch bar receiver about a horizontal axis and preventing translation of the rotatable hitch bar receiver.

At least a portion of the rotatable hitch bar receiver 106 may at least partially overlap the width W of the hitch bar 102 at an extreme of a rotational angle of the rotatable hitch bar receiver 106 major axis X₂ away from the hitch bar 102 major axis X₁ (e.g., see FIGS. 9A, 9B α₁, α₂). The rotatable hitch bar receiver 106 may at least partially overlap the width W of the hitch bar 102 at all rotational angles of the rotatable hitch bar receiver 106 relative to the hitch bar 102.

As used herein, the width W of the hitch bar 102 includes a rearward projection from the outside edges of the hitch bar 102, as shown in FIG. 1. Accordingly, a rotatable hitch bar receiver 106 that is at least partially rearward from the rearward end if the hitch bar at least partially overlaps the width W of the hitch bar 102 if a portion of the rotatable hitch bar receiver 106 intersects an area between lines projected rearward from vertical walls of the hitch bar.

A rearward end (i.e., a load hitch bar receiving end) of the rotatable hitch bar receiver 106 may at least partially overlap the width W of the hitch bar 102 at all rotational angles.

The rotatable hitch bar receiver 106 may be rotatable in two directions away from the hitch bar major axis X₁.

The rotation apparatus 101 may include an axle 502 and an axle housing 104, coupled together by a bearing surface. As shown in FIGS. 5 and 6, the bearing surface may include a pair of oppositely inclined bearings and/or bushings that prevent vertical translation of the axle 502 relative to the axle housing 104.

According to an embodiment, the hitch bar 102 may be formed with one corner and about one-quarter of the abutting horizontal and vertical walls extending a full length. A wedge 116 is formed to nominally occupy a space sloping away from the full length corner, such that tightening a hitch wedge bolt 118 causes the wedge 116 to slide along the sloping end of the hitch bar 102 to expand and securely hold the hitch bar in place. An internal spring (not shown) substantially prevents the wedge 116 from engaging too early in the insertion process, allowing the hitch bar 102 to be inserted easily. Structure and operation of the hitch bar 102, hitch bar wedge 116, and hitch wedge bolt 118, as well as a sports rack referenced herein, are described more fully in U.S. patent application Ser. No. 18/155,696 (docket number 3065-001-08), entitled Anti-Rattle Hitch Mounted Rack, filed Jan. 17, 2023, and incorporated by reference herein.

A hitch bar pin 120 is shown inserted through the hitch bar 102. In one embodiment, the rotatable hitch bar receiver 106 includes holes 302 to accept a load hitch bar pin (not shown) to secure a load hitch bar in the rotatable hitch bar receiver 106. In another embodiment, the rotatable hitch bar receiver 106 is formed to have a shortened length L to allow a load hitch bar pin to extend through a load hitch bar (not shown) beyond a forward end of the rotatable hitch bar receiver 106.

According to an embodiment, at least one of the axle 502 or axle housing 104 intersects the major axis X₁ of the hitch bar 102. The rotation apparatus 101 is configured to rotate the rotatable hitch bar receiver 106 about a vertical axis defined by the axle to maintain a major axis X₂ of the rotatable hitch bar receiver 106 within a plane parallel to a vehicle hitch bar receiver.

The hitch bar receiver 106 may be operable to swing or rotate a load supported by the hitch bar receiver to a side when a user accesses a rear door, tailgate, or hatch of the vehicle.

The coupling apparatus 100 may include a load operatively coupled to the hitch bar receiver 106. In another embodiment, a load may be coupled to the rotation apparatus 101 and the hitch bar receiver 106 may be omitted. An embodiment of this arrangement is shown in FIG. 10.

The hitch bar load may include a sports rack operatively coupled to the rotatable hitch bar receiver 106. The sports rack may include a tilt mechanism for selectable tilt away from the vehicle. Alone or in combination, rotation of the rotatable hitch bar receiver and tilt of the sports rack may be operable to provide access to a rear compartment or surface of the vehicle.

According to embodiments, the rotation apparatus 101 includes a rotation brake. The rotation brake may include a fixed lock plate and at least one latch 110, 112 operable to maintain respective major axes X₁, X₂ of the hitch bar 102 and the rotatable hitch bar receiver 106 parallel to one another when the load is in a position for vehicle travel. The at least one latch 110, 112 may include a pawl 112 configured to snap into one of a plurality of notches 802, 804, 806 in a lock plate 108 as the rotation apparatus reaches respective pre-determined angular positions. For example, see FIGS. 8, 9A, and 9B. The at least one latch 110, 112 may include a spring-biased pin fastener 110 configured to be retracted from the lock plate 108 by a user, such as when the user wishes to rotate the hitch bar load.

The coupling apparatus 100 may include a rotation brake. The rotation brake may include a lock plate 108 fixedly coupled with respect to or integral with the rotatable hitch bar receiver 106 and at least one latch 110, 112 fixedly coupled with respect to to the hitch bar 102. In another embodiment, the rotation brake may include a lock plate 108 fixedly coupled to or integral with the hitch bar 102 and at least one latch 110, 112, fixedly coupled with respect to the rotatable hitch bar receiver 106. The lock plate 108 may, in combination with the at least one latch 110, 112, form a rotation brake configured to resist or prevent rotation of a load coupled to the rotatable hitch bar receiver 106.

According to an embodiment, a horizontally rotating hitch adaptor 100 for a vehicle includes a hitch bar 102 having a major axis X₁ and a width W perpendicular to the major axis, the hitch bar 102 being configured to couple to a vehicle hitch bar receiver (not shown). In an embodiment, a vertical axle housing 104 is operatively coupled to the hitch bar 102. A vertical axle 502 is rotatably supported by the vertical axle housing 104. A rotatable hitch bar receiver 106 having a major axis X₂ is operatively coupled to and configured to rotate with the vertical axle 502. Accordingly, an object coupled to the rotatable hitch bar receiver 106 is rotatable around a vertical axis defined by the vertical axle housing 104 and the vertical axle 502.

While the drawings herein depict the vertical axle housing 104 extending upward from the hitch bar 102, it is noted that the designations “top” and “bottom” are used for ease of understanding. The apparatus 100 may be inserted “upside down” relative to the drawings and operate, especially in situations where a user wished to raise rather than lower a hitch bar load relative to the vehicle hitch bar receiver.

In an embodiment, the vertical axle housing 104 at least partially intersects the width W of the hitch bar 102. For example, the vertical axle 502 may at least partially intersect the width W of the hitch bar. In an embodiment, the vertical axle 502 and the vertical axle housing define an axis of rotation intersecting the hitch bar 102 major axis X₁.

In another embodiment, the vertical axle housing 104 is supported by the hitch bar 102 and an intermediate member (not shown) at a lateral location not intersecting the width of the hitch bar. For example, the vertical axle housing 104 and the vertical axle 502 may define an axis of rotation disposed at least one foot to the left or to the right of the hitch bar 102. In another example, the vertical axle housing 104 and the vertical axle 502 may define an axis of rotation disposed at a location closer to alignment with left or right wheels of the vehicle (not shown) than to the major axis X₁ of the hitch bar.

According to an embodiment, a horizontally rotating hitch adaptor 100 includes one or more bushings or bearings 504, 506 configured to support the vertical axle 502 for rotation relative to the vertical axle housing. A castellated nut 508 may be coupled to the vertical axle 502 and configured to hold a lower bushing or bearing 504 and an upper bushing or bearing 506 in contact with both the vertical axle housing 104 and the vertical axle 502 (e.g., within a bearing tolerance).

According to an embodiment, the horizontally rotating hitch adaptor 100 includes a lock plate 108 fixedly coupled to either the vertical axle 502 or to the vertical axle housing 104 and one or more latches 110, 112 operatively coupled to the the other of the vertical axle housing 104 or the vertical axis 502. The one or more latches 110, 112 may be configured to engage the lock plate 108 to maintain a selected rotational position of the vertical axle 502 relative to the vertical axle housing 104; and thereby maintain a selected rotational position of the rotatable hitch bar receiver 106 relative to the hitch bar 102. Referring especially to FIGS. 8, 9A, and 9B, the selected rotational position of the vertical axle 502 relative to the vertical axle housing 104 may correspond to a selected angle zero (0), alpha 1 (α₁), or alpha 2 (α₂) of the rotatable hitch bar receiver 106 relative to the hitch bar 102 via notches 802, 804, 806 in the lock plate 108.

The one or more latches 110, 112 may include a spring loaded pin 110. Additionally or alternatively, the one or more latches 110, 112 may include a spring loaded pawl 112.

According to an embodiment, a horizontally rotating hitch adaptor 100 includes a hitch bar 102, a vertical axle 502, a vertical axle housing 104, and a rotatable hitch bar receiver 106. The hitch bar 102 may have a major axis X₁ and a width W perpendicular to the major axis. The hitch bar 102 may be configured to couple to a vehicle hitch bar receiver (not shown). The vertical axle 502 may be operatively coupled to the hitch bar 102. The vertical axle housing 104 may be rotatably supported by the vertical axle 502. The rotatable hitch bar receiver 106 may be operatively coupled to and configured to rotate with the vertical axle housing 104 relative to the vertical axle 502. In this way, an object coupled to the rotatable hitch bar receiver 106 (e.g., see the rotatable payload 1002 shown in FIG. 10) is rotatable around a vertical axis defined by the vertical axle housing 104 and the vertical axle 502.

FIG. 10 is a diagram of a vehicle trailer hitch-mountable cargo carrier 1000, according to an embodiment. Referring to FIG. 10 and to FIGS. 1-8, 9A, and 9B, the vehicle trailer hitch-mountable cargo carrier 1000 includes a hitch bar 102 having a width W, configured to couple to a vehicle hitch bar receiver (not shown). A rotatable payload 1002 is operatively coupled to and completely supported by the hitch bar for transport by the vehicle. A rotation apparatus 101 is operatively coupled to the hitch bar 102 to the rotatable payload 1002. The rotation apparatus is configured to support and rotate the rotatable payload 1002 about a vertical axis of rotation located within the width W of the hitch bar 102. The rotatable payload is configured to rotate in a horizontal plane while being supported by the hitch bar 102.

A rotation lock 108, 110, 112 may be configured to prevent rotation of the rotatable payload 1002 while the rotation lock is engaged. In an embodiment, the rotation lock 108, 110, 112 includes a lock plate 108 fixedly coupled with respect to the hitch bar 102 or the rotatable payload 1002 and one or more latches 110, 112 fixedly coupled with respect to the other of the rotatable payload 1002 or the hitch bar 102.

In an embodiment, the rotation apparatus 101 includes an axle housing 104 fixedly coupled to the hitch bar and an axle 502 supported by the axle housing, fixedly coupled to the payload, and configured to rotate within the axle housing. The axle housing 104 may be integral with the hitch bar 102.

In another embodiment, the rotation apparatus 101 includes an axle 502 fixedly coupled to the hitch bar 102 and an axle housing 104 fixedly coupled to the payload 1002 and configured to rotate about the axle 502, the axle supporting the axle housing 104 and the payload 1002. The axle housing 104 may be integral with the payload.

The rotation apparatus 101 may include two bearings or bushings 504, 506 configured to support an axle 502 relative to an axle housing 104 to prevent vertical movement of the axle 502 relative to the axle housing 104, to prevent vertical movement of the payload 1002 relative to the hitch bar 102, and to allow the axle to rotate relative to the axle housing.

The vehicle trailer hitch-mountable cargo carrier 1002 may include a rack for sports equipment, as shown in FIG. 10. For example, the vehicle trailer hitch-mountable cargo carrier 1002 may include a bicycle rack.

In another embodiment, the vehicle trailer hitch-mountable cargo carrier 1002 includes a platform for a scooter or wheelchair.

While various aspects and embodiments have been disclosed herein, other aspects and embodiments are contemplated. The various aspects and embodiments disclosed herein are for purposes of illustration and are not intended to be limiting, with the true scope and spirit being indicated by the following claims.

What is claimed is:

1. A coupling apparatus for rotating a hitch bar load relative to a major axis of a vehicle, comprising:
a hitch bar, having a major axis X₁ and a width W, configured to couple to a vehicle hitch bar receiver;
a rotatable hitch bar receiver having a major axis X₂; and
a rotation apparatus operatively coupled between the hitch bar and the rotatable hitch bar receiver, configured to rotate the rotatable hitch bar receiver about a vertical axis relative to the hitch bar while preventing rotation of the rotatable hitch bar receiver about a horizontal axis and preventing translation of the rotatable hitch bar receiver.

2. The coupling apparatus for rotating the hitch bar load relative to the major axis of the vehicle of claim 1, wherein at least a portion of the rotatable hitch bar receiver at least partially overlaps the width W of the hitch bar at an extreme of a rotational angle of the rotatable hitch bar receiver major axis X₂ away from the hitch bar major axis X₁.

3. The coupling apparatus for rotating the hitch bar load relative to the major axis of the vehicle of claim 2, wherein at least a portion of the rotatable hitch bar receiver at least partially overlaps the width W of the hitch bar at all rotational angles of the rotatable hitch bar receiver 106 relative to the hitch bar 102.

4. The coupling apparatus for rotating the hitch bar loadrelative to the major axis of the vehicle of claim 3, wherein a rearward end of the rotatable hitch bar receiver, distal from the vehicle when used, at least partially overlaps the width W of the hitch bar at all rotational angles.

5. The coupling apparatus for rotating the hitch bar load relative to the major axis of the vehicle of claim 1, wherein the rotatable hitch bar receiver is rotatable in two directions away from the hitch bar major axis X₁.

6. The coupling apparatus for rotating the hitch bar load relative to the major axis of the vehicle of claim 1, wherein the rotation apparatus includes an axle and an axle housing, coupled together by a bearing surface.

7. The coupling apparatus for rotating the hitch bar load relative to the major axis of the vehicle of claim 6, wherein at least one of the axle or axle housing intersects the major axis X₁ of the hitch bar.

8. The coupling apparatus for rotating the hitch bar load relative to the major axis of the vehicle of claim 1, wherein the rotation apparatus is configured to rotate the rotatable hitch bar receiver about a vertical axis to maintain a major axis X₂ of the rotatable hitch bar receiver in a plane parallel to a vehicle hitch bar receiver.

9. The coupling apparatus for rotating the hitch bar load relative to the major axis of the vehicle of claim 1, wherein the hitch bar receiver is operable to rotate a load supported by the hitch bar receiver to a side when a user accesses a rear door, tailgate, or hatch of the vehicle.

10. The coupling apparatus for rotating the hitch bar load relative to the major axis of a vehicle of claim 1, wherein:
the hitch bar load includes a sports rack operatively coupled to the rotatable hitch bar receiver, the sports rack including a tilt mechanism for selectable tilt away from the vehicle;
wherein alone or in combination, rotation of the rotatable hitch bar receiver and tilt of the sports rack provides access to a rear compartment or surface of the vehicle.

11. The coupling apparatus for rotating the hitch bar load relative to the major axis of the vehicle of claim 1, wherein the rotation apparatus includes at least one latch operable to maintain respective major axes X₁, X₂ of the hitch bar and the rotatable hitch bar receiver parallel to one another when the load is in a position for vehicle travel.

12. The coupling apparatus for rotating the hitch bar load relative to the major axis of the vehicle of claim 1, wherein the rotation apparatus includes a rotation brake pawl configured to snap into one of a plurality of notches in a lock plate fixedly coupled to the rotatable hitch bar receiver as the rotation apparatus reaches respective pre-determined angular positions.

13. The coupling apparatus for rotating the hitch bar load relative to the major axis of the vehicle of claim 1, wherein the rotation apparatus includes a spring-biased pin fastener configured to be retracted by a user from lock plate fixedly coupled to the rotatable hitch bar receiver.

14. The coupling apparatus for rotating the hitch bar load relative to the major axis of the vehicle of claim 1, further comprising:
a lock plate mechanically coupled to the hitch bar, the lock plate forming a rotation brake, in combination with one or more latches 110, 112, configured to resist rotation of a load coupled to the rotatable hitch bar receiver.

15. A horizontally rotating hitch adaptor for a vehicle, comprising:
a hitch bar having a major axis X₁ and a width W perpendicular to the major axis, the hitch bar being configured to couple to a vehicle hitch bar receiver;
a vertical axle housing operatively coupled to the hitch bar;
a vertical axle rotatably supported by the vertical axle housing; and
a rotatable hitch bar receiver having a major axis X₂ operatively coupled to and configured to rotate with the vertical axle;
wherein an object coupled to the rotatable hitch bar receiver is rotatable in either of two directions around a vertical axis defined by the vertical axle housing and the vertical axle.

16. The horizontally rotating hitch adaptor of claim 15, wherein the vertical axle housing at least partially intersects the width W of the hitch bar.

17. The horizontally rotating hitch adaptor of claim 16, wherein the vertical axle at least partially intersects the width W of the hitch bar.

18. The horizontally rotating hitch adaptor of claim 16, wherein the vertical axle and the vertical axle housing define an axis of rotation intersecting the hitch bar width W.

19. The horizontally rotating hitch adaptor of claim 15, further comprising one or more bushings or bearings configured to support the vertical axle for rotation relative to the vertical axle.

20. The horizontally rotating hitch adaptor of claim 19, wherein the one or more bushings or bearings includes a lower bushing or bearing and an upper bushing or bearing, the horizontally rotating hitch adaptor further comprising a castellated nut coupled to the vertical axle and configured to hold the lower bushing or bearing and the upper bushing or bearing in contact with both the vertical axle housing and the vertical axle.

21. The horizontally rotating hitch adaptor of claim 15, further comprising a lock plate affixed either to the vertical axle or to the vertical axle housing; and
one or more latches operatively coupled to the other of the vertical axle housing or the vertical axle and configured to engage the lock plate to maintain a selected rotary position of the vertical axle relative to the vertical axle housing.

22. The horizontally rotating hitch of claim 21, wherein the selected rotary position of the vertical axle relative to the vertical axle housing corresponds to a selected angle zero (0), alpha 1 (α₁), or alpha 2 (α₂) of the rotatable hitch bar receiver relative to the hitch bar.

23. The horizontally rotating hitch of claim 21, wherein the one or more latches includes a spring loaded pin.

24. The horizontally rotating hitch of claim 21, wherein the one or more latches includes a spring loaded pawl.

25. A vehicle trailer hitch-mountable cargo carrier, comprising:
a hitch bar 102 having a width W configured to couple to a vehicle hitch bar receiver;
a rotatable cargo carrier 1002 operatively coupled to and completely supported by the hitch bar for transport by the vehicle; and
a rotation apparatus 101 operatively coupled to the hitch bar 102 and to the rotatable cargo carrier 1002, the rotation apparatus being configured to rotate the rotatable cargo carrier about a vertical axis of rotation located within the width W of the hitch bar.

26. The vehicle trailer hitch-mountable cargo carrier of claim 25, further comprising:
a rotation lock 108, 110, 112 configured to prevent rotation of the rotatable cargo carrier 1002 while the rotation lock is engaged.

27. The vehicle trailer hitch-mountable cargo carrier of claim 26, wherein the rotation lock 108, 110, 112 includes:
a lock plate 108 fixedly coupled with respect to the hitch bar 102 or the rotatable cargo carrier 1002; and
one or more latches 110, 112 fixedly coupled with respect to the other of the rotatable cargo carrier 1002 or the hitch bar 102.

28. The vehicle trailer hitch-mountable cargo carrier of claim 25, wherein the rotation apparatus 101 includes:
an axle housing 104 fixedly coupled to the hitch bar; and
an axle 502 supported by the axle housing, fixedly coupled to the cargo carrier, and configured to rotate within the axle housing.

29. The vehicle trailer hitch-mountable cargo carrier of claim 28, wherein the axle housing 104 is integral with the hitch bar 102.

30. The vehicle trailer hitch-mountable cargo carrier of claim 25, wherein the rotation apparatus 101 includes:
an axle 502 fixedly coupled to the hitch bar 102; and
an axle housing 104 fixedly coupled to the cargo carrier 1002 and configured to rotate about the axle 502, the axle supporting the axle housing 104 and the cargo carrier 1002.

31. The vehicle trailer hitch-mountable cargo carrier of claim 30, wherein the axle housing 104 is integral with the cargo carrier.

32. The vehicle trailer hitch-mountable cargo carrier of claim 25, wherein the rotation apparatus 101 includes:
two bearings or bushings 504, 506 configured to support an axle 502 relative to an axle housing 104 to prevent vertical movement of the axle 502 relative to the axle housing 104, to prevent vertical movement of the cargo carrier 1002 relative to the hitch bar 102, and to allow the axle to rotate relative to the axle housing.

33. The vehicle trailer hitch-mountable cargo carrier of claim 25, wherein the vehicle trailer hitch-mountable cargo carrier 1002 includes a rack for sports equipment.

34. The vehicle trailer hitch-mountable cargo carrier of claim 33, wherein the vehicle trailer hitch-mountable cargo carrier 1002 includes a bicycle rack.

35. The vehicle trailer hitch-mountable cargo carrier of claim 25, wherein the vehicle trailer hitch-mountable cargo carrier 1002 includes a platform for a scooter or wheelchair.
